(19) United States
(12) Patent Application Publication
(10) Pub. No.: US 2010/0072708 A1
(43) Pub. Date: Mar. 25, 2010

(54) SEAL ASSEMBLY

(75) Inventor: Edward James CARGILL, Leduc (CA)

Correspondence Address: RODMAN RODMAN, 10 STEWART PLACE, SUITE 2CE, WHITE PLAINS, NY, 10603, US

(73) Assignee: ENGINEERING DESIGN RESOURCES LTD., Leduc (CA)

(21) Appl. No.: 12/234,212

(22) Filed: Sep. 19, 2008

(51) Int. Cl. E21B 33/10; F16J 15/34

(52) U.S. Cl. 277/336; 277/403

(57) ABSTRACT

A seal assembly for providing a seal between a first component and a second component. The seal assembly includes a seal ramp associated with one of the components and a seal element associated with the other of the components. The seal ramp has an inclined seal ramp surface having a lower end and an upper end. The seal element is engaged with the seal ramp surface to provide the seal. The seal ramp and the seal element are movable relative to each other to enable the seal element to move along the seal ramp surface toward the upper end of the seal ramp surface. A seal energizing device urges the seal element toward the upper end of the seal ramp surface.

### TECHNICAL FIELD

A seal assembly for providing a seal between a first component and a second component.

### BACKGROUND OF THE INVENTION

In the oil and gas drilling industry, and in other industries, there is an established need for a seal design that will effectively inhibit the intrusion of contaminants into a contaminant sensitive area. This need is particularly high for dynamic seal applications, such as rotary seal applications.

An example of this would he the primary rotary seals of a rotary steerable drilling tool where the internal electrical and mechanical systems are contained within an oil filled body and the tool has a rotating shaft passing through it. Intrusion of the contaminant bearing drilling mud into the oil filled body would effectively destroy the integrity of the electrical and mechanical systems of the tool.

A further example of the application of rotary seals would be in a sealed bearing unit of a positive displacement drilling motor. Any intrusion of drilling mud or contaminants into the bearing unit would rapidly destroy the effectiveness of the bearings.

In both of these examples, the effective life of the drilling tool can be limited by the effective life of the rotary seals. It is therefore of the utmost importance to ensure that the rotary seals have a meaningful effective life.

One of the most popular and currently most effective rotary seal designs is offered by Kalsi Engineering, Inc. of Houston, Tex. In the typical Kalsi Seal™ design, the sealing element is installed in an housing and remains fixed with respect to lateral movement along the axis of the rotating sealing surface. Incorporated into the sealing face of the Kalsi Seal™ element is a profile which purports to create a pumping action to transfer oil across the sealing face to provide lubrication to the sealing interface.

In one design recommendation of Kalsi Engineering Inc., a secondary Kalsi Seal™ is used as a barrier to prevent contaminant material reaching the primary fixed Kalsi Seal™. This is described as a translating seal arrangement wherein one of the sealing elements is effectively a sacrificial seal.

Another design approach incorporating Kalsi Seals™ utilizes a doublet, fixed seal arrangement where again the outer seal is a sacrificial barrier to abrasive media. The elastomeric seals maintain a sealing contact between the stationary and rotating members by virtue of the radial force generated by the radial compression of the elastomeric sealing material. The useful life of the seals is determined by the wear of the pumping profile at the sealing interface. As the material of the contacting sealing surfaces wears, the pumping effect and therefore the lubrication of the seal is reduced. The effective compression, and thereby the radial contact force, is also reduced. Wear and therefore reduction of the radial sealing force occurs when there is relative motion between the stationary and rotating members of the seal assembly. The seal is regarded as having failed when there is transfer of oil to the contaminant side of the seal and/or transfer of contaminant to the oil side of the seal.

There remains a need for a seal design in which the seal remains effective following some wear or deterioration of the contacting sealing elements and/or surfaces.

### SUMMARY OF THE INVENTION

References in this document to dimensions, to operating parameters, to ranges, to lower limits of ranges, and to upper limits of ranges are not intended to provide strict boundaries for the scope of the invention, but should be construed to mean “approximately” or “about” or “substantially”, within the scope of the teachings of this document, unless expressly stated otherwise.

The present invention is a seal assembly for providing a seal between a first component and a second component in which the seal remains effective following some wear or deterioration of the contacting sealing elements or surfaces. The seal assembly may be described as “self renewing”, since wear of the contacting sealing elements or surfaces results in relative movement of the contacting sealing surfaces and an adjusted configuration of the seal.

The first component and the second component may be adapted to remain stationary relative to each other or may be adapted to move relative to each other.

In one embodiment the invention is a seal assembly for providing a seal between a first component and a second component, wherein the seal assembly has a seal assembly axis, the seal assembly comprising:
(a) a seal ramp associated with one of the first component and the second component, wherein the seal ramp has a seal ramp surface, wherein the seal ramp surface has a lower end and an upper end which are axially spaced along the seal assembly axis, and wherein the seal ramp surface is inclined relative to the seal assembly axis between the lower end of the seal ramp surface and the upper end of the seal ramp surface;
(b) a seal element associated with the other of the first component and the second component, wherein the seal element is engaged with the seal ramp surface in order to provide the seal, and wherein the seal ramp and the seal element are movable relative to each other in order to enable the seal element to move along the seal ramp surface toward the upper end of the seal ramp surface; and
(c) a seal energizing device for urging the seal element toward the upper end of the seal ramp surface.

The first component and the second component may be comprised of components of any structure, device or apparatus in which one component must be sealed relative to another component. The required seal may be a static seal or a dynamic seal. The dynamic seal may be a rotary seal or a reciprocating seal.

In some embodiments, the first component may be a rotating component and the second component may be a non-rotating component. In some embodiments, the first component may be comprised of a shaft and the second component may be comprised of a housing. The shaft may have a shaft axis, and the shaft may be adapted to rotate relative to the housing about the shaft axis.

The seal assembly axis may be oriented in any suitable direction relative to the first and second components. In some embodiments where the first component is comprised of a shaft having a shaft axis, the seal assembly axis may be parallel to the shaft axis.

The seal ramp and the seal element may be associated with either the first component or the second component. In some embodiments, the seal ramp may be associated with the first component and the seal element may be associated with the second component.

The seal ramp may be movable relative to the seal element, the seal element may be movable relative to the seal ramp, or both the seal ramp and the seal element may be movable so that the seal ramp and the seal element are movable relative to each other in order to enable the seal element to move along the seal ramp surface toward the upper end of the seal ramp surface.

The seal energizing device may therefore be configured to urge the seal ramp to move relative to the seal element to urge the seal element to move relative to the seal ramp, or to urge both the seal ramp and the seal element to move relative to each other so that the seal element is urged toward the upper end of the seal ramp surface.

In some embodiments, the seal element is movable relative to the seal ramp in order to enable the seal element to move along the seal ramp surface toward the upper end of the seal ramp surface and the seal energizing device therefore urges the seal element to move relative to the seal ramp so that the seal element is urged toward the upper end of the seal ramp surface.

As a result, in a second embodiment, the invention is a seal assembly for providing a seal between a shaft and a housing, wherein the seal assembly has a seal assembly axis, wherein the shaft has a shaft axis, wherein the seal assembly axis is parallel with the shaft axis, and wherein the shaft is adapted to rotate relative to the housing about the shaft axis, the seal assembly comprising:
(a) a seal ramp associated with the shaft, wherein the seal ramp has a seal ramp surface, wherein the seal ramp surface has a lower end and an upper end which are axially spaced along the seal assembly axis, and wherein the seal ramp surface is inclined relative to the seal assembly axis between the lower end of the seal ramp surface and the upper end of the seal ramp surface;
(b) a seal element associated with the housing, wherein the seal element is engaged with the seal ramp surface in order to provide the seal, and wherein the seal element is movable relative to the seal ramp in order to enable the seal element to move along the seal ramp surface toward the upper end of the seal ramp surface; and
(c) a seal energizing device for urging the seal element toward the upper end of the seal ramp surface.

In various embodiments of the invention, the first component and the second component may define a circumferential seal chamber therebetween, wherein the seal chamber has a cross-sectional area transverse to the seal assembly axis, wherein the seal ramp and the seal element are both positioned within the seal chamber in order to provide the seal, and wherein less of the cross-sectional area of the seal chamber is available to be occupied by the seal element at the upper end of the seal ramp surface than at the lower end of the seal ramp surface.

The seal ramp may be comprised of any suitable structure, device or apparatus which is capable of providing the functions of the seal ramp. The seal ramp may be comprised of a single part or may be comprised of a plurality of parts. The seal ramp may be attached to or connected with the first component or the second component, or the seal ramp may be integral with the first component or the second component.

In some embodiments, the seal ramp may be removably attached to or connected with the first component or the second component so that the seal ramp is replaceable. In some embodiments, parts of the seal ramp may be individually replaceable, thereby avoiding replacement of the entire seal ramp. In some embodiments in which the seal ramp is associated with a shaft as the first component, the seal ramp may be comprised of a ramp sleeve surrounding the shaft. In some embodiments, the ramp sleeve may be removably attached to or connected with the shaft so that the ramp sleeve is replaceable.

The seal element may be comprised of any suitable structure, device or apparatus which is capable of providing the functions of the seal element. The seal element may be comprised of a single part or may be comprised of a plurality of parts. The seal element may be attached to or connected with the first component or the second component, or the seal element may be integral with the first component or the second component.

In some embodiments, the seal element may be removably attached to or connected with the first component or the second component so that the seal element is replaceable. In some embodiments, parts of the seal element may be individually replaceable, thereby avoiding replacement of the entire seal element. In some embodiments in which the seal element is associated with a housing as the second component, the seal element may be removably attached to or connected with the housing so that the seal element is replaceable.

The seal ramp surface and the seal element engage with each other to provide the seal. As a result, the seal ramp surface and the seal element may be constructed of any material or combination of materials which are capable of providing the sealing function. The seal element may be comprised of a seal element surface which engages the seal ramp surface. The seal element surface may be constructed of the same material or combination of materials as the other portions of the seal element or may be constructed of a different material or combination of materials. The seal ramp may be constructed of the same material or combination of materials as the seal ramp surface or may be constructed of a different material or combination of materials. The seal ramp may be coated with a material or combination of materials in order to provide the seal ramp surface. The seal element may be coated with a material or combination of materials in order to provide the seal element surface.

The seal element surface may be less wear resistant than the seal ramp surface, the seal element surface may be more wear resistant than the seal ramp surface, or the seal element surface and the seal ramp surface may be equally wear resistant.

In some embodiments, the seal element surface is less wear resistant than the seal ramp surface so that the seal element or parts thereof are more frequently replaceable than the seal ramp or parts thereof. In some embodiments, all or parts of the seal ramp may be constructed of or coated with hardened steel, ceramic material, glass, aluminum bronze, carbide or diamond. In some embodiments, all or parts of the seal element may be constructed of or coated with Nylon™, Teflon™, PEEK™ or rubber.

The seal element may engage with the seal ramp surface in any suitable manner. In some embodiments, the seal element surface may have an area and the entire area of the seal element surface may engage with the seal ramp surface to provide a contact area of engagement between the surfaces. In some embodiments, only a portion of the area of the seal element surface may engage with the seal ramp surface to provide the contact area of engagement between the surfaces.

The seal ramp surface has a seal ramp surface angle relative to the seal assembly axis. The seal ramp surface angle must be small enough to facilitate movement of the seal element along the seal ramp surface toward the upper end of the seal element surface and must be large enough to enable the seal assembly to compensate for a desired amount of wear or deterioration of the seal ramp and the seal element while facilitating maintaining an effective seal over the distance between the lower end of the seal ramp surface and the upper end of the seal ramp surface. As a non-limiting example, in some embodiments, the seal ramp surface angle may be between about 10 degrees and about 30 degrees. As a non-limiting example, in some embodiments, the seal ramp surface angle may be about 15 degrees.

The seal element surface may have a seal element surface angle relative to the seal assembly axis. In some embodiments, the amount of the area of the seal element surface which engages with the seal ramp surface is dependent upon the seal ramp surface angle and the seal element surface angle. In some embodiments, the seal element surface angle may be equal to the seal ramp surface angle so that substantially all of the seal element surface engages with the seal ramp surface in order to provide the seal. In some embodiments, the seal element surface angle may be greater than the seal ramp surface angle so that only a portion of the seal element surface engages with the seal ramp surface in order to provide the seal. Although potentially feasible, it is generally not preferred for some embodiments that the seal element surface angle be less than the seal ramp surface angle.

As a non-limiting example, in some embodiments in which the seal ramp surface angle may be between about 10 degrees and about 30 degrees, the seal element surface angle may be between about 10 degrees and about 45 degrees. As a non-limiting example, in some embodiments in which the seal ramp surface angle may be about 15 degrees, the seal element surface angle may be between about 15 degrees and about 30 degrees.

The seal may define an interior side of the seal assembly and an exterior side of the seal assembly so that the interior side is sealed from the exterior side by the seal. As a result, the seal assembly may isolate fluids on the interior side of the seal from fluids on the exterior side of the seal.

In some embodiments, the interior side of the seal may represent the interior environment of a structure, device or apparatus and the exterior side of the seal may represent the surrounding environment of the structure, device or apparatus. The interior environment of the structure, device or apparatus may be relatively “clean”, while the surrounding environment may be relatively contaminated.

In some embodiments, the seal assembly may be configured so that the upper end of the seal ramp surface is located on the interior side of the seal assembly so that the seal element is urged toward portions of the seal ramp surface which are located within the relatively clean interior environment of the structure, device or apparatus in which the seal assembly is used.

The seal energizing device may urge movement of one or both of the seal ramp and the seal element by exerting a seal energizing force on one or both of the seal ramp and the seal element. The seal energizing force may be provided mechanically, hydraulically, electrically, or in any other suitable manner.

The seal energizing device may be comprised of any suitable device or combination of devices which are capable of providing the functions of the seal energizing device. In some embodiments, the seal energizing device may be comprised of one or more springs so that movement of one or both of the seal ramp and the seal element is urged by a spring force. In some embodiments, the spring may be comprised of one or more Belleville springs.

In some embodiments in which the seal element is movable relative to the seal ramp and in which the seal element is associated with a housing as the second component, the seal energizing device may be comprised of a spring which is positioned within the housing.

The seal assembly of the invention may be used in any application in which some wear or deterioration of the seal ramp and/or the seal element may be expected. As wear or deterioration occurs, the seal element is urged along the seal ramp surface toward the upper end of the seal ramp surface, thereby providing a “wedging” effect. As the amount of wear or deterioration increases, the seal element is urged further along the seal ramp surface so that the seal element becomes engaged with portions of the seal ramp surface which have not previously been contacted with the seal element. As a result, the seal contacting surfaces are “renewed” as wear or deterioration occurs and the seal element is urged toward the upper end of the seal ramp surface.

### BRIEF DESCRIPTION OF DRAWINGS

Embodiments of the invention will now be described with reference to the accompanying drawings, in which:

FIG. 1 is a longitudinal section schematic drawing depicting an embodiment of a seal assembly according to the invention as incorporated into a rotary steerable drilling tool, wherein FIG. 1B is a continuation of FIG. 1A.

FIG. 2 is a detail drawing of the portion of the rotary steerable drilling tool which is designated as 2 in FIG. 1A.

FIG. 3 is a detail drawing of the portion of the rotary steerable drilling tool which is designated as 3 in FIG. 2.

### DETAILED DESCRIPTION

The present invention is a seal assembly for providing a seal between a first component and a second component of a structure, device or apparatus. In some embodiments, the first component and the second component may not move relative to each other so that the seal may be a static seal. In some embodiments, first component and the second component may move relative to each other so that the seal may be a dynamic seal. In some embodiments, the first component may be a rotating component and the second component may be a non-rotating component. In some embodiments, the rotating component may be comprised of a shaft and the non-rotating component may be comprised of a housing.

In some embodiments, the rotating component and the non-rotating component may be components of a tool for use in a borehole. By way of non-limiting examples, the tool may be a drilling tool such as a drilling motor or a rotary steerable drilling tool. In some embodiments, the invention may be used in a structure, device or apparatus which is unrelated to the drilling of boreholes.

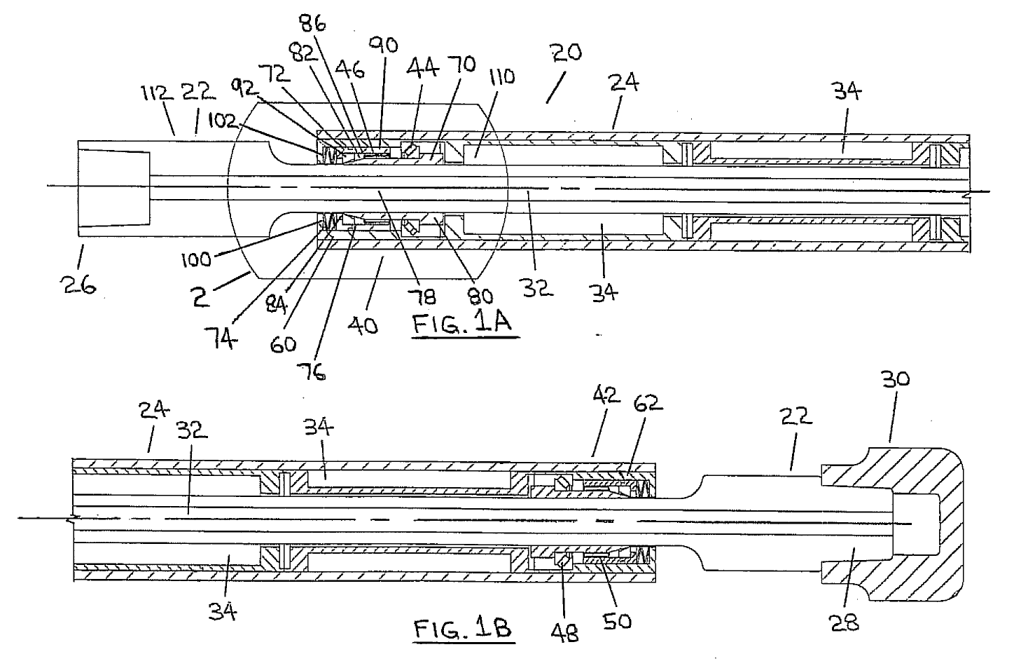

In the description of a specific embodiment of the invention that follows, the seal assembly provides a dynamic seal in a drilling tool between a rotatable shaft as a first component and a housing as a second component. As depicted in FIGS. 1-3, the rotatable shaft is a shaft of a rotary steerable drilling tool and the housing is the housing of a rotary steerable drilling tool. FIGS. 1-3 and the description that follows therefore provide a non-limiting example of a specific embodiment and a specific application of the invention.

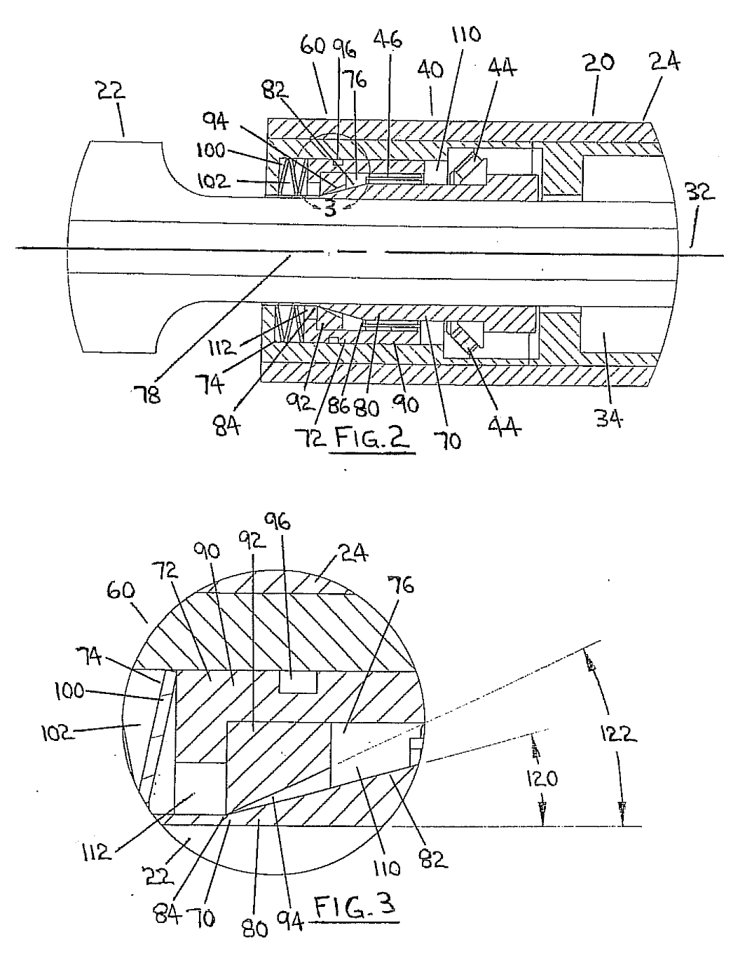

FIG. 1 is a longitudinal section schematic drawing of a rotary steerable drilling tool. FIG. 2 is a detail drawing of the portion of the drilling tool which is designated by (2) in FIG. 1A. FIG. 3 is a detail drawing of the portion of the drilling tool which is designated by (3) in FIG. 2.

Referring to FIG. 1, a rotary steerable drilling tool (20) for use in drilling boreholes includes a shaft (22) and a housing (24). The shaft (22) has a proximal end (26) and a distal end (28). The proximal end (22) of the shaft (22) attaches to a drill string (not shown). A drill bit (30) attaches to the distal end (24) of the shaft (22). The shaft (22) is rotatably mounted within the housing (24) so that the shaft (22) may rotate relative to the housing (24) about a shaft axis (32).

The housing (24) contains various electrical and mechanical components (not shown) of the drilling tool (20). Accordingly, the housing (24) includes cavities (34) for receiving the electrical and mechanical components.

To facilitate the rotation of the shaft (22) relative to the housing (24), the drilling tool (20) includes an upper bearing (40) and a lower bearing (42) which are interposed between the shaft (22) and the housing (24). The upper bearing (40) includes an upper thrust bearing (44) and an upper radial bearing (46). The lower bearing (42) includes a lower thrust bearing (48) and a lower radial bearing (50).

The bearings (40,42) are lubricated with a lubricating fluid (not shown). To contain the lubricating fluid and to prevent contaminants from outside the drilling tool (20) from contacting the bearings (40,42) and other components of the drilling tool which are located within the housing (24), the drilling tool (20) is provided with an upper seal assembly (60) and a lower seal assembly (62). As depicted in FIG. 1, the upper seal assembly (60) and the lower seal assembly (62) include identical parts. As a result, only the upper seal assembly (60) will be described in detail in the description that follows.

Referring to FIGS. 1-3, the upper seal assembly (60) is comprised of a seal ramp (70), a seal element (72), and a seal energizing device (74). The seal ramp (70) and the seal element (72) are positioned within a circumferential seal chamber (76) defined between the shaft (22) and the housing (24). The upper seal assembly (60) has a seal assembly axis (78) which is parallel with the shaft axis (32).

As depicted in FIGS. 1-3, the seal ramp (70) is associated with the shaft (22). More particularly, the seal ramp (70) is comprised of a ramp sleeve (80) which surrounds and is mounted on the shaft (22). The seal ramp (70) is fixedly mounted on the shaft (22) so that the seal ramp (70) does not rotate or move axially relative to the shaft (22). The seal ramp (70) is removably mounted on the shaft (22) so that the seal ramp (70) may be replaced, if necessary.

The seal ramp (70) has a seal ramp surface (82). The seal ramp surface (82) has a lower end (84) and an upper end (86) which are axially spaced along the seal assembly axis (78). The seal ramp surface (82) is inclined relative to the seal assembly axis (78) between the lower end (84) and the upper end (86).

As depicted in FIGS. 1-3, the seal element (72) is associated with the housing (24). More particularly, the seal element (72) is comprised of a seal element sleeve (90) and a seal element ring (92) which is mounted on the seal element sleeve (90). The seal element (72) is reciprocably mounted within the housing (24) so that the seal element (72) is capable of an amount of axial movement along the seal assembly axis (78) relative to the housing (24) and the seal ramp (70). The seal element (72) is keyed to the housing (24) so that the seal element (72) does not rotate relative to the housing (24). The seal element (72) is removably mounted within the housing (24) so that the seal element (72) can be replaced, if necessary. The seal element ring (92) is removably mounted on the seal element sleeve (90) so that the seal element ring (92) can be removed from the seal element sleeve (90) and replaced as necessary.

The seal element ring (92) has a seal element surface (94). The seal element surface (94) is engaged with the seal ramp surface (82) in order to provide a seal between the seal ramp (70) and the seal element (72). A housing seal (96) provides a seal between the seal element sleeve (90) and the housing (24).

The seal energizing device (74) urges the seal element (72) to move relative to the seal ramp (70) toward the upper end (86) of the seal ramp surface (82). As depicted in FIGS. 1-3, the seal energizing device (74) is comprised of a spring (100) which is positioned in the housing (24). More particularly, as depicted in FIGS. 1-3 the spring (100) is comprised of a plurality of Belleville springs which are arranged in a spring cavity (102).

The spring (100) provides a seal energizing force which is applied to the seal element (72). The seal energizing force assists in maintaining the seal element (72) in engagement with the seal ramp surface (82) and urges the seal element (72) to move along the seal ramp surface (82) toward the upper end (86) of the seal ramp surface (82).

The appropriate amount of the seal energizing force to be provided by the spring (100) may be dependent upon many considerations, including but not limited to the geometries of the seal ramp (70) and the seal element (72), the materials selected for the seal ramp (70) and the seal element (72), the overall design of the drilling tool (20), and the conditions under which the drilling tool (20) will be operated. In some applications in which the drilling tool (20) is a rotary steerable drilling tool, it is estimated that a suitable seal energizing force to be provided by the spring (100) may be about 250 pounds or about 113 kilograms.

The seal chamber (76) has a cross-sectional area which is transverse to the seal assembly axis. The cross-sectional area is occupied by the seal ramp (70) and the seal element (72). The seal ramp (70) occupies more of the cross-sectional area of the seal chamber (76) at the upper end (86) of the seal ramp surface (82) than at the lower end (84) of the seal ramp surface (82), with the result that less of the cross-sectional area of the seal chamber (76) at the upper end (86) of the seal ramp surface (82) is available to be occupied by the seal element (72) than at the lower end (84) of the seal ramp surface (82).

Consequently, the urging of the seal element (72) toward the upper end (86) of the seal ramp surface (82) urges the seal element (72) toward a smaller area and space, and thus “wedges” the seal element (72) between the housing (24) and the seal ramp (70). As the seal element (72) and/or the seal ramp (70) wear or deteriorate during use of the drilling tool (20), a loss or compression of material will result in the seal element (72) being moved by the seal energizing device (74) along the seal ramp surface (82) toward a portion of the seal chamber (76) having a smaller cross-sectional area available to be occupied by the seal element (72). Furthermore, movement of the seal element (72) along the seal ramp surface (82) provides for renewal of the seal contact surfaces provided by the seal ramp surface (82) and the seal element surface (94).

The seal provided by the engagement of the seal element with the seal ramp surface defines an interior side (110) of the upper seal assembly (60) and an exterior side (112) of the upper seal assembly (60) so that the interior side (110) is sealed from the exterior side (112).

Referring to FIG. 1, the interior side (110) of the upper seal assembly (60) represents the interior environment of the drilling tool (20), while the exterior side (112) of the upper seal assembly (60) represents the surrounding environment of the drilling tool (20).

More particularly, the upper bearing (40) and the lower bearing (42) are both located on the interior side (110) of the upper seal assembly (60), and the combined effect of the upper seal assembly (60) and the lower seal assembly (62) is to seal or isolate the relatively “clean” interior environment of the drilling tool (20) from the relatively contaminated surrounding environment of the drilling tool (20).

The seal ramp surface (82) is divided axially by engagement with the seal element (72) so that the lower end (84) of the seal ramp surface (82) is located on the exterior side (112) of the upper seal assembly (60) and the upper end (86) of the seal ramp surface (82) is located on the interior side (110) of the upper seal assembly (60). As a result, the seal element (72) is urged toward portions of the seal ramp surface (82) which are located on the interior side (110) of the upper seal assembly (60) and are thus isolated from contaminants. This configuration assists in ensuring that a positive seal between the seal ramp (70) and the seal element (72) can be maintained as the seal element (72) moves up the seal ramp surface (82) toward the upper end (86) of the seal ramp surface.

The seal ramp (70) and/or the seal ramp surface (82) may be replaced or repaired if they experience an unacceptable amount of wear or deterioration. Similarly, the seal element sleeve (90), the seal element ring (92) and/or the seal element surface (94) may be replaced or repaired if they experience an unacceptable amount of wear or deterioration.

Referring to FIGS. 1-3, the seal element surface (94) and the seal ramp surface (82) may be designed to be equally wear resistant. Alternatively, the seal element surface (94) may be designed to be more wear resistant than the seal ramp surface (82) so that the seal ramp surface (82) wears preferentially to the seal element surface (94).

Alternatively, the seal element surface (94) may be designed to be less wear resistant than the seal ramp surface (82) so that the seal element surface (94) wears preferentially to the seal ramp surface (82). For example, all or parts of the seal ramp (70) may be constructed of or coated with hardened steel, ceramic material, glass, aluminum bronze, carbide or diamond, and all or parts of the seal element ring (92) may be constructed of or coated with Nylon™, Teflon™, PEEK™ or rubber so that the seal element surface (94) tends to wear preferentially to the seal ramp surface (82).

Referring to FIG. 3, the seal ramp surface (82) has a seal ramp surface angle (120) relative to the seal assembly axis (78) and the seal element surface (94) has a seal element surface angle (122) relative to the seal assembly axis (78). In the embodiment depicted in FIGS. 1-3, the seal element surface angle (122) is greater than or equal to the seal ramp surface angle (120).

If the seal element surface angle (122) is equal to the seal ramp surface angle (120), the contact area of engagement between the seal element surface (94) and the seal ramp surface (82) will be relatively large, may remain relatively constant during use of the upper seal assembly (60), and the upper seal assembly (60) may wear relatively slowly.

If the seal element surface angle (122) is greater than the seal ramp surface angle (120), the contact area of engagement between the seal element surface (94) and the seal ramp surface (82) will be relatively smaller and may result in the upper seal assembly (60) wearing relatively more quickly as the contact surfaces wear or deteriorate. This potential accelerated wearing effect may tend to increase as the difference between the seal element surface angle (122) and the seal ramp surface angle (120) increases.

As depicted in FIG. 3, the seal ramp surface angle (120) is about 15 degrees and the seal element surface angle is about 25 degrees.

During use of the drilling tool (20), the upper seal assembly (60) and the lower seal assembly (62) will protect the upper bearing (40), the lower bearing (42) and other components contained in the interior environment of the drilling tool (20) by preventing or inhibiting contaminants from the surrounding environment of the drilling tool (20) from entering the interior environment of the drilling tool (20) and by preventing or inhibiting the loss of lubricating fluid from the interior environment of the drilling tool (20).

The seal element (72) will be urged into engagement with the seal ramp surface (82) by the seal energizing device (74). As the upper seal assembly (60) wears due to the relative rotation between the shaft (22) and the housing (24), the seal element (72) is urged Lip the seal ramp surface (82) by the seal energizing device (74) toward the upper end (86) of the seal ramp surface (82) to accommodate for loss or compression of the materials making up the seal ramp (70) and the seal element (72).

When the seal element (72) has moved so that it is at or near the upper end (86) of the seal ramp surface (82), the upper seal assembly (60) may be replaced or repaired by removing and replacing or repairing the seal ramp (70), the seal element (72) or parts thereof.

The seal assemblies (60,62) of the invention may be adapted to a variety of applications and for a variety of operating conditions by varying the seal ramp surface angle (120) and the seal element surface angle (122), by varying the materials used to construct the seal ramp (70) and the seal element (72), and by varying the seal energizing force which is provided by the seal energizing device (74).

The invention may also be adapted for different applications by varying the configurations of the seal ramp (70), the seal element (72) and the seal energizing device (74). As one example, the seal ramp (70) may be associated with a non-rotating component and the seal element (72) may be associated with a rotating component. As a second example, the seal ramp (70) may be configured to move relative to the seal element (72) or both the seal ramp (70) and the seal element (72) may be configured to move relative to each other in order to enable the seal element (72) to move toward the upper end (86) of the seal ramp surface (82). As a third example, the seal assembly of the invention may be adapted for use in applications which do not require a seal between a rotating component and a non-rotating component.

In this document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The embodiments of the invention in which an exclusive property or privilege is: claimed are defined as follows:

1. A seal assembly for providing a seal between a first component and a second component, wherein the seal assembly has a seal assembly axis, the seal assembly comprising:
(a) a seal ramp associated with one of the first component and the second component, wherein the seal ramp has a seal ramp surface, wherein the seal ramp surface has a lower end and an upper end which are axially spaced along the seal assembly axis, and wherein the seal ramp surface is inclined relative to the seal assembly axis between the lower end of the seal ramp surface and the upper end of the seal ramp surface;
(b) a seal element associated with the other of the first component and the second component, wherein the seal element is engaged with the seal ramp surface in order to provide the seal, and wherein the seal ramp and the seal element are movable relative to each other in order to enable the seal element to move along the seal ramp surface toward the upper end of the seal ramp surface; and
(c) a seal energizing device for urging the seal element toward the upper end of the seal ramp surface.

2. The seal assembly as claimed in claim 1 wherein the first component and the second component define a circumferential seal chamber therebetween, wherein the seal chamber has a cross-sectional area transverse to the seal assembly axis, wherein the seal ramp and the seal element are both positioned within the seal chamber in order to provide the seal, and wherein less of the cross-sectional area of the seal chamber is available to be occupied by the seal element at the upper end of the seal ramp surface than at the lower end of the seal ramp surface.

3. The seal assembly as claimed in claim 2 wherein the first component is comprised of a shaft, wherein the second component is comprised of a housing, wherein the shaft has a shaft axis, and wherein the shaft is adapted to rotate relative to the housing about the shaft axis.

4. The seal assembly as claimed in claim 3 wherein the seal assembly axis is parallel with the shaft axis.

5. The seal assembly as claimed in claim 4 wherein the seal ramp is associated with the shaft and wherein the seal element is associated with the housing.

6. The seal assembly as claimed in claim 5 wherein the seal ramp is comprised of a ramp sleeve surrounding the shaft.

7. The seal assembly as claimed in claim 4 wherein the seal element is movable relative to the seal ramp in order to enable the seal element to move along the seal ramp surface toward the upper end of the seal ramp surface.

8. The seal assembly as claimed in claim 7 wherein the seal energizing device is comprised of a spring.

9. The seal assembly as claimed in claim 8 wherein the seal ramp is associated with the shaft, wherein the seal element is associated with the housing, and wherein the spring is positioned within the housing.

10. The seal assembly as claimed in claim 4 wherein the seal defines an interior side of the seal assembly and an exterior side of the seal assembly so that the interior side is sealed from the exterior side by the seal, and wherein the upper end of the seal ramp surface is located on the interior side of the seal assembly.

11. The seal assembly as claimed in claim 10 wherein the seal ramp surface has a seal ramp surface angle relative to the seal assembly axis, wherein the seal element is comprised of a seal element surface for engaging with the seal ramp surface, wherein the seal element surface has a seal element surface angle relative to the seal assembly axis, and wherein the seal element surface angle is equal to the seal ramp surface angle.

12. The seal assembly as claimed in claim 10 wherein the seal ramp surface has a seal ramp surface angle relative to the seal assembly axis, wherein the seal element is comprised of a seal element surface for engaging with the seal ramp surface, wherein the seal element surface has a seal element surface angle relative to the seal assembly axis, and wherein the seal element surface angle is greater than the seal ramp surface angle.

13. The seal assembly as claimed in claim 4 wherein the seal element is comprised of a seal element surface for engaging with the seal ramp surface and wherein the seal element surface is less wear resistant than the seal ramp surface.

14. The seal assembly as claimed in claim 4 wherein the seal element is comprised of a seal element surface for engaging with the seal ramp surface and wherein the seal element surface is more wear resistant than the seal ramp surface.

15. A seal assembly for providing a seal between a shaft and a housing, wherein the seal assembly has a seal assembly axis, wherein the shaft has a shaft axis, wherein the seal assembly axis is parallel with the shaft axis, and wherein the shaft is adapted to rotate relative to the housing about the shaft axis, the seal assembly comprising:
(a) a seal ramp associated with the shaft, wherein the seal ramp has a seal ramp surface, wherein the seal ramp surface has a lower end and an upper end which are axially spaced along the seal assembly axis, and wherein the seal ramp surface is inclined relative to the seal assembly axis between the lower end of the seal ramp surface and the upper end of the seal ramp surface;
(b) a seal element associated with the housing, wherein the seal element is engaged with the seal ramp surface in order to provide the seal, and wherein the seal element is movable relative to the seal ramp in order to enable the seal element to move along the seal ramp surface toward the upper end of the seal ramp surface; and
(c) a seal energizing device for urging the seal element toward the upper end of the seal ramp surface.

16. The seal assembly as claimed in claim 15 wherein the shaft and the housing define a circumferential seal chamber therebetween, wherein the seal chamber has a cross-sectional area transverse to the seal assembly axis, wherein the seal ramp and the seal element are both positioned within the seal chamber in order to provide the seal, and wherein less of the cross-sectional area of the seal chamber is available to be occupied by the seal element at the upper end of the seal ramp surface than at the lower end of the seal ramp surface.

17. The seal assembly as claimed in claim 16 wherein the seal ramp is comprised of a ramp sleeve surrounding the shaft.

18. The seal assembly as claimed in claim 16 wherein the seal energizing device is comprised of a spring and wherein the spring is positioned within the housing.

19. The seal assembly as claimed in claim 16 wherein the seal defines an interior side of the seal assembly and an exterior side of the seal assembly so that the interior side is sealed from the exterior side by the seal, and wherein the upper end of the seal ramp surface is located on the interior side of the seal assembly.

20. Tile seal assembly as claimed in claim 16 wherein the seal ramp surface has a seal ramp surface angle relative to the seal assembly axis, wherein the seal element is comprised of a seal element surface for engaging with the seal ramp surface, wherein the seal element surface has a seal element surface angle relative to the seal assembly axis, and wherein the seal element surface angle is equal to the seal ramp surface angle.

21. The seal assembly as claimed in claim 16 wherein the seal ramp surface has a seal ramp surface angle relative to the seal assembly axis, wherein the seal element is comprised of a seal element surface for engaging with the seal ramp surface, wherein the seal element surface has a seal element surface angle relative to the seal assembly axis, and wherein the seal element surface angle is greater than the seal ramp surface angle.

22. The seal assembly as claimed in claim 16 wherein the seal element is comprised of a seal element surface for engaging with the seal ramp surface and wherein the seal element surface is less wear resistant than the seal ramp surface.

23. The seal assembly as claimed in claim 16 wherein the seal element is comprised of a seal element surface for engaging with the seal ramp surface and wherein the seal element surface is more wear resistant than the seal ramp surface.
